(19) United States
(12) Patent Application Publication
(10) Pub. No.: US 2004/0225548 A1
(43) Pub. Date: Nov. 11, 2004

(54) System and method for promoting informed use of a group retirement plan

(75) Inventors: Roberta L. Aldrich, Downington, PA (US); Monica J. Kirgan, Polk City, IA (US); James A. Aldridge, Des Moines, IA (US); Lisa M. Fritz, Urbandale, IA (US); Mark A. Glavin, Mercer Island, WA (US); Carl L. Moore, Des Moines, IA (US); Jack E. Stewart, Ankeny, IA (US); Deborah W. Tezak, Des Moines, IA (US); Scott J. Heidesch, Johnston, IA (US)

Correspondence Address: MCKEE, VOORHEES & SEASE, P.L.C., 801 GRAND AVENUE, SUITE 3200, DES MOINES, IA, 50309-2721, US

(73) Assignee: PRINCIPAL FINANCIAL SERVICES, INC., Des Moines, IA (US)

(21) Appl. No.: 10/792,542

(22) Filed: Mar. 2, 2004

Related U.S. Application Data
(60) Provisional application No. 60/451,329, filed on Mar. 3, 2003.

(51) Int. Cl. G06F 17/60

(52) U.S. Cl. 705/8

(57) ABSTRACT

A system and method for encouraging or promoting proper and/or informed use of group retirement plans is disclosed. In one aspect, the present invention is used to identify the need for changes in plan use or administration and provide appropriate solutions for encouraging or promoting the changes. An assessment tool is used to collect information regarding characteristics associated with group retirement plan. Based on this assessment, areas in need of change are identified, and areas in need of change and appropriate solutions are prioritized.

### CROSS-REFERENCE TO RELATED APPLICATIONS

This application is a conversion of U.S. Provisional Application Ser. No. 60/451,329, filed Mar. 3, 2003, which is herein incorporated by reference in its entirety.

### BACKGROUND OF THE INVENTION

The present invention relates to a method and system for promoting informed use of a retirement plan, such as, but not limited to a 401(K) group retirement plan.

The widespread use of such plans, particularly employer-sponsored retirement saving plans, provides retirement plan participants with a valuable vehicle for planning for retirement. Unfortunately, not everyone takes advantage of such plans and/or the options associated with such plans. Therefore, there is a real need in the art for an improvement relative to retirement plans. Thus, it is a principal object of the present invention to provide a method and system that improves over or solves the problems and deficiencies in the art.

Another object of the present invention is to provide a method and system that provides a basis for sponsors to identify that participants are not taking full advantage of their retirement plan.

Another object of the present invention is to provide a method and system that allow plan sponsors to assess their own administration of a plan and to determine the desirability of particular changes in the plan.

A further object of the present invention is to provide a method and system for providing tools and training to plan participants in need of such training through a plan provider.

A further object of the present invention is to provide solutions by a plan provider and/or plan sponsor to plan participants to address problems identified in their use of a plan.

These and/or other objects, features, or advantages of the present invention shall become apparent from the specification and claims that follow.

### SUMMARY OF THE INVENTION

According to one aspect of the present invention, a system for promoting informed use of a group retirement plan is provided. The system includes an assessment tool provided by a group retirement plan provider to a group retirement sponsor to identify the desirability for change in one or more items related to the group retirement plan. The assessment tool can be in the form of a worksheet, can be offered online, or otherwise be provided. The assessment tool can allow a group retirement sponsor to compare their answers to an industry wide average for similarly situated group retirement sponsors. Based on these comparisons, areas of change are identified and a specific plan of action is formulated.

According to another aspect of the present invention, a method for promoting informed use of the group retirement plan is provided. The method includes providing an assessment tool to group retirement sponsors, promoting use of the assessment tool by a group retirement sponsor to identify desirability of changes to the plan or training relating to the plan, and assisting a group retirement sponsor in providing changes in the plan or training relating to the plan.

According to another aspect of the present invention, the present invention provides a method for determining tools and/or training materials to be provided to participants of a group retirement plan. The method includes assessing at least one of a plurality of group retirement plan characteristics for a plan provider, comparing at least one of the plurality of group retirement plan characteristics to a corresponding benchmark characteristic, and prioritizing tools and/or training to be provided to participants of the plan associated with the plan provider at least partially based on the step of comparing. The tools or training can be of various types and forms.

### BRIEF DESCRIPTION OF THE DRAWINGS

FIG. 1 is a diagram showing one embodiment of the flow of information, tools and training between a plan provider, a plan sponsor, and a plan participant.

FIG. 2 is a flow diagram showing one embodiment of the collection of participant and plan information and the prioritization of areas.

FIG. 3 is a block diagram showing one embodiment of a computer assisting in the implementation of the present invention.

### DETAILED DESCRIPTION OF THE PREFERRED EMBODIMENT

The present invention relates to the effective communication of information regarding a group retirement plan from a plan provider to a plan sponsor and plan participants. In addition, the present invention relates to encouraging or promoting effective use of the plan and options associated with the plan by a plan sponsor and plan participants.

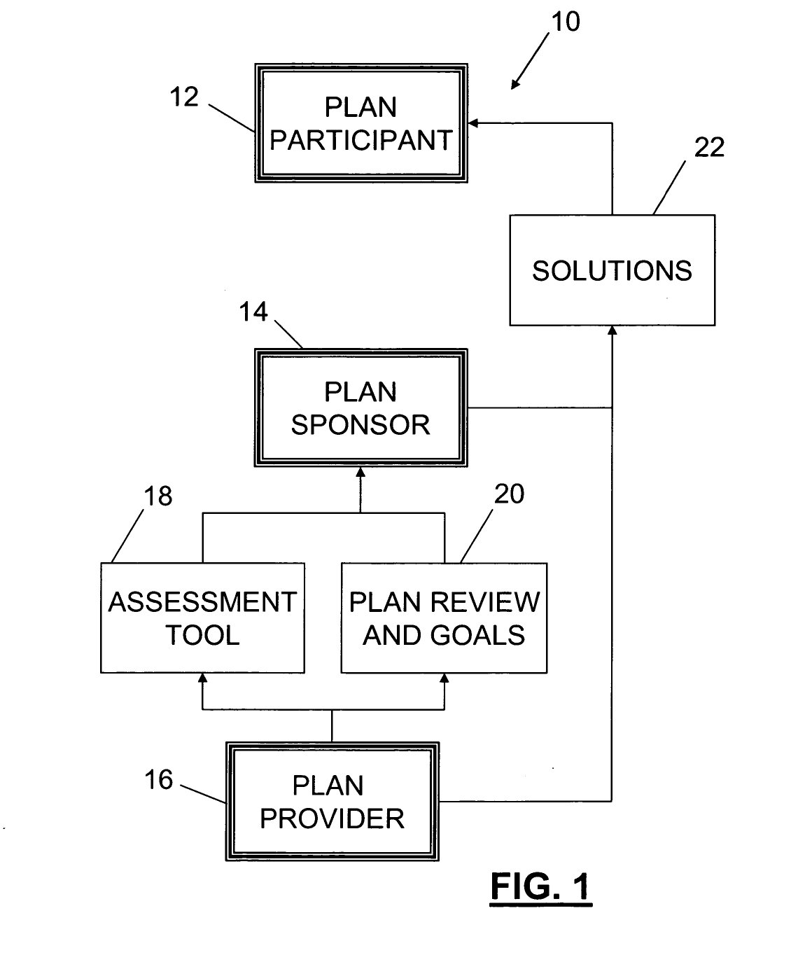

FIG. 1 illustrates a system 10 according to one embodiment of the invention. In system 10, a plan participant 12 is shown, along with a corresponding plan sponsor 14 who is normally the employer of each plan participant 12. Also, there is a plan provider 16 shown. According to one embodiment of the present invention, the plan provider 16 provides an assessment tool 18. The assessment tool 18 is provided to the plan sponsor 14. The assessment tool 14 allows a plan sponsor to evaluate their implementation and their participants' use of their plan to determine if it is being used in a manner consistent with others in the industry, or in a manner that could be changed or improved. Of course the goal of such a retirement plan is to provide for the participant's future.

The assessment tool examines the most common areas for improvement in retirement plans. These areas include plan design, increase in participation and enrollment, maximizing deferral percentages, and providing education and assistance to plan participants. The assessment tool provides for comparing the current status of a plan to a corresponding benchmark, such as industry-wide statistics.

Through this assessment procedure and through comparison of the results for a plan sponsor to benchmarks, a plan sponsor can determine the specific areas of improvement for their retirement plan. Once these areas are identified, they are preferably prioritized.

For each problem identified, the plan provider proposes different solutions. The particular solutions vary in nature and require varying amounts of employee time commitment and employer involvement.

For example, one problem is to maximize participation in a plan. One solution to maximizing participation is for plan sponsors or employers to offer automatic enrollment of employees into the plan. Another example of a solution to maximize participation is for the employer or plan sponsor to offer an incentive campaign. Another example of a solution to maximize participation is to have an enrollment meeting to raise awareness of the plan. The present invention provides that some of the solutions offered are in fact training sessions that are preferably provided by or through the plan provider.

Other potential problems can be addressed in appropriate ways. For example to address the problem of increasing deferrals, a retirement plan checkup in the form of a seminar and/or book can be provided to employees/plan participants. Alternatively, an increase deferral campaign can be used that encourages participants to increase their contributions. Another potential solution to increase deferrals is to offer an incentive campaign to provide incentives such as alarm clocks, desk calculators, or other items to those that increase their deferrals by a particular amount.

The present invention provides for identifying other types of problems as well, including improving participant education, and encouraging examination of and changes in plan design. Similarly, the present invention provides for different solutions for each problem identified.

As shown in FIG. 1, the plan provider 16 provides the solutions 22 to the plan sponsor 14 and the plan participants 12. In addition, the plan provider can distribute to the plan sponsors 14 and receive a completed “Plan Review and Goals” 20 to track what the goals of the plan sponsor 14 are, the tactical plan used to assess those goals and the results of applying the solutions to the plan.

In this manner, the plan sponsors can evaluate and identify potential problems or the need for changes in their plan. In addition, the plan sponsor 14 can identify the need for education and training of employee/participants 12 in order to enhance the employee/participants' 12 use of the plan. The present invention contemplates that a computer can be used in assisting in the performance of one or more steps in various methodologies of the present invention. For example, the assessment tool can be implemented in software.

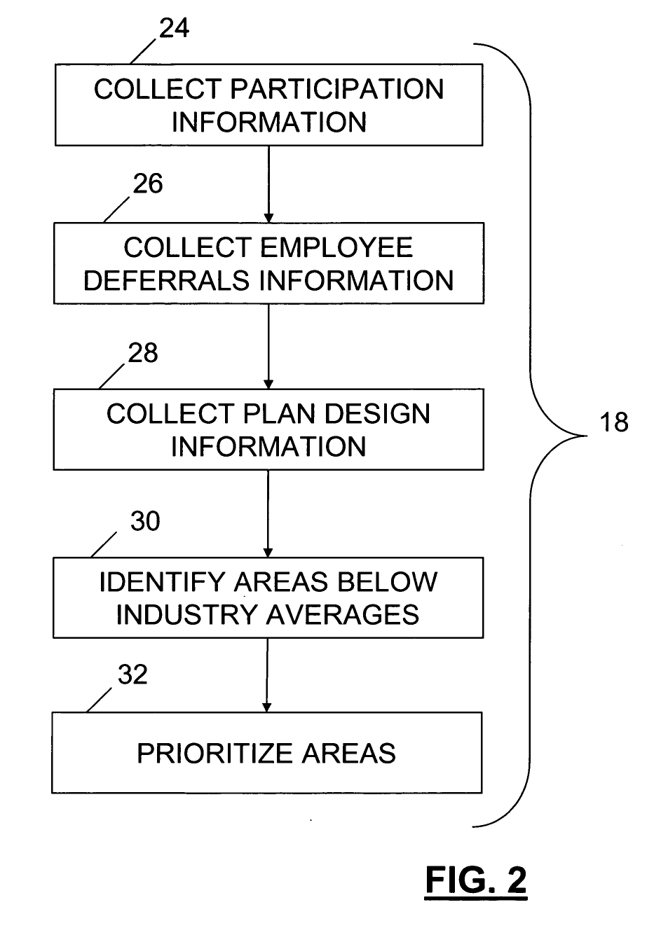

FIG. 2 illustrates one embodiment of the methodology of assessment tool 18. In step 24, the assessment tool is used to collect participation information. Participation information can include, but is certainly not limited to: how long a new employee must wait before they can participate in the plan; the percentage of eligible employees that actually participate in the plan; and whether participants are automatically enrolled in the plan.

The present invention also contemplates that information regarding employee deferral, can be collected. Such information is collected in step 26. Information regarding employee deferrals can include, but is not limited to the average percent of pay that participants contribute to the plan.

Although not shown in FIG. 2, the present invention further contemplates that information regarding participant education can be collected. This information can include, but is not limited to whether or not the plan sponsor offers participants access to investing advice, the percentage of employees that have minimal knowledge of investing, the percentage of employees within 10 years of retirement, or other characteristics or measurements of participant education.

In step 28, information regarding plan design is collected. Information regarding plan design, includes, but is not limited to how many investment options are offered and how many investment options participants use on average, whether or not participants are allowed to take plan loans, how soon participants become vested in company contributions, whether the plan sponsor has an investment policy statement, and the current level of employer matching of participant contributions.

The present invention contemplates that the various information collected can be collected in various manners. For example, a representative of a plan sponsor can merely fill out a form provided by a plan provider. The form can be paper-based or electronic. Alternatively, some of the information may be electronically collected.

Next in step 30, particular areas or items that are below industry averages or other benchmarks are examined. Although preferred benchmarks include industry averages obtained from Annual Profit Sharing/401(K) Council of America Surveys, Boston Research Group 401(K) Participation Studies, or Spectrem's 401(K) Market Needs Studies, other industry averages can be used. The present invention further contemplates that historical information for the plan sponsor can be used to assess if there have been statistically significant changes in participation, employee deferrals, or other types of characteristics.

Where the benchmarks used are based on industry averages, or other industry statistics, the present invention provides for comparing the characteristics associated with the plan sponsor and/or its participants with industry averages to identify where these characteristics require improvement in order to reach industry statistics. The present invention contemplates that this comparison can be completed in any number of ways. In one embodiment, when information is collected in the form of a worksheet, the industry averages can be presented on the worksheet so that the plan sponsor will immediately be aware that characteristics of its plan or its participants significantly deviate from industry norms. Alternatively, if information is collected electronically, this information can be presented in the form of a computer generated-report or displayed on screen.

Next in step 32, the areas, items or characteristics are prioritized. It is preferred that the item that most deviates from the benchmark, or the item otherwise deemed most important, be given the highest priority. The present invention contemplates that not every area or item need be prioritized; for example, only those in most need of change can be prioritized.

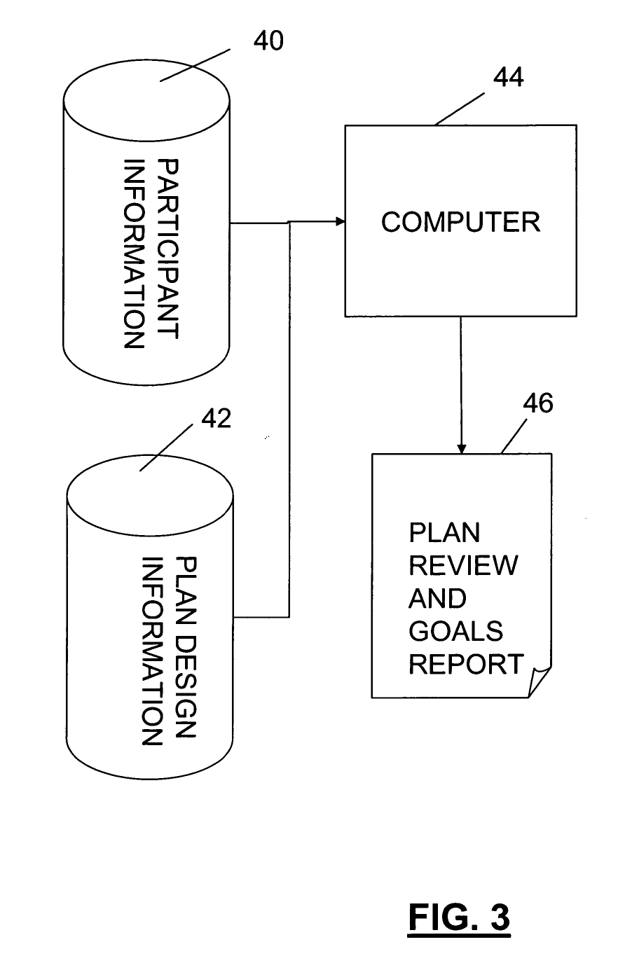

FIG. 3 illustrates one embodiment of a system of the present invention. In FIG. 3, participant information 40 and/or plan design information 42 is collected by a computer 44. The computer 44 can assist in comparing collected information with benchmarks as well as in the prioritizing of information. The results of this information can be displayed or printed in a “plan review and goals report” 46. The present invention contemplates that the report 46 can include proposed solutions or available solutions to improve upon areas that were identified as being below the benchmarks. The report can include a summary of goals, a tactical plan to meet the goals, and also results achieved by implementation of the tactical plan. Thus, it should be appreciated that the plan is updated so that as various solutions are implemented, the results can be recorded.

Thus, it should be understood that the present invention provides for a method of promoting informed use of a retirement plan by providing a tool to plan sponsors to assess their use of the retirement plan and their participant's use of the retirement plan, and to identify and address potential problems.

The present invention is in no way limited to the particular type of plan or implementation of plan used. In addition, the present invention is not limited to particular problems that are identified in a plan or any particular solutions that are proposed to address those problems. Rather, the present invention contemplates numerous variations in the type of plan, the problems associated with the plan, the solutions to the plan, the training to plan participants or employees, the incentives to plan participants or employees, the manner in which a computer may be used to perform or assist in performing one or more steps, and other variations within the spirit and scope of the invention.

What is claimed is:

1. A method for determining tools and training material to be provided to participants of a group retirement plan, comprising:
providing an assessment tool to a group retirement plan sponsor, the assessment tool providing instructions for:
(a) determining at least one of a plurality of group retirement plan characteristics for the group retirement plan provider;
(b) comparing at least one of the plurality of group retirement plan characteristics to a corresponding benchmark characteristic;
prioritizing tools and training material to be provided to participants of the plan associated with the plan provider at least partially based on the step of comparing.

2. The method of claim 1 further comprising deferring the tools and training to the participants.

3. The method of claim 1 wherein the benchmark is an industry average.

4. The method of claim 1 wherein the benchmark is an industry wide average of similarly situated plan providers.

5. The method of claim 1 wherein the plan provider is an employer.

6. The method of claim 1 wherein the group retirement plan is a 401(K) plan.

7. The method of claim 2 wherein the tools and training are at least partially provided by a group retirement plan provider.

8. The method of claim 1 wherein at least one of the plurality of group retirement plan characteristics is selected from the set comprising a participation characteristic, an employee deferral characteristic, a participant education characteristic, and a plan design characteristic.

9. The method of claim 1 wherein the tools and training to be provided to participants of a plan is selected from the set comprising (a) offering automatic enrollment, (b) providing an incentive campaign, (c) offering an enrollment meeting, (d) offering a retirement plan check-up, (e) providing an increase deferral campaign, (f) providing an increase deferral incentive campaign, (g) providing an understanding investment training, (h) providing a preparing for retirement training, (i) providing information on plan design.

10. A method for promoting informed use of a group retirement plan, comprising:
providing an assessment tool to a group retirement plan sponsor, the assessment tool adapted to collect information from the group retirement plan sponsor and identify and prioritize items in need of change;
promoting use of the assessment tool by a group retirement plan sponsor to identify desirability of changes to the plan and training relating to the plan;
assisting a group retirement plan sponsor in providing changes to the plan and training relating to the plan to implement solutions by addressing one or more of the items in need of change.

11. The method of claim 10 wherein the steps of providing, promoting and assisting are performed by a group retirement plan provider.

12. The method of claim 11 wherein the assessment tool collects a plurality of group retirement plan characteristics and facilitates comparing each of the plurality of group retirement characteristics to a corresponding benchmark characteristic.

13. The method of claim 12 wherein the plurality of group retirement plan characteristics include a participation characteristic, an employee deferral characteristic, a participant education characteristic, and a plan design characteristic.

14. The method of claim 13 wherein the solutions include offering automatic enrollment, providing an incentive campaign, offering an enrollment meeting, offering a retirement plan check-up, providing an increase deferral campaign, providing an increase deferral incentive campaign, providing an understanding investment training, providing a preparing for retirement training, and providing information on plan design.

15. A system for promoting informed use of a group retirement plan, comprising:
an assessment tool provided by a group retirement provider to a group retirement sponsor to identify desirability of a change in one or more items related to the group retirement plan.

16. The system of claim 15 further comprising training material for one or more items related to the group retirement plan.

17. The system of claim 15 further comprising incentives related to changes in one or more items related to the group retirement plan.
